(19) United States
(12) Patent Application Publication
(10) Pub. No.: US 2016/0217482 A1
(43) Pub. Date: Jul. 28, 2016

(54) USE-BASED SOFTWARE INCENTIVES

(71) Applicant: International Business Machines Corporation, Armonk, NY (US)

(72) Inventors: John E. Moore, JR., Brownsburg, IN (US); Jeffrey K. Price, Austin, TX (US); Robert R. Wentworth, Round Rock, TX (US); Stanley C. Wood, Round Rock, TX (US)

(21) Appl. No.: 15/096,324

(22) Filed: Apr. 12, 2016

Related U.S. Application Data
(63) Continuation of application No. 14/278,607, filed on May 15, 2014.

(51) Int. Cl. G06Q 30/02

(52) U.S. Cl. CPC G06Q 30/0209; G06Q 30/0257

(57) ABSTRACT

A computer system identifies a ranking, and a fee for a user of a game. A computer system determines an amount to adjust the fee for the user of the game based upon the ranking of the user. Responsive to determining the amount to adjust the fee, a computer system updates the fee for the user of the game.

### FIELD OF THE INVENTION

The present invention relates generally to the field of user-based computing services, and more particularly to linking fees to subscriber actions.

### BACKGROUND OF THE INVENTION

A video game is an electronic game that involves human interaction with a user interface to generate visual feedback on a video device. The word video device implies any type of display device that can produce two- or three-dimensional images. Electronic systems used to play video games are generally known as platforms; examples of these are personal computers (PCs) and video game consoles. These platforms can range from large mainframe computers to small handheld devices. Some multiplayer video games have a leaderboard to keep track of the best players and to allow a user to know their rank among other players.

Many video games have multiplayer video game applications which are capable of supporting large numbers of players simultaneously. By necessity, some multiplayer online games are played on the Internet. Multiplayer online games usually have at least one persistent world; however, some games differ. Multiplayer online games can be found for most network-capable platforms, including PC's, video game consoles, smartphones, or other mobile devices.

Multiplayer video games can enable players to cooperate and/or compete with each other on a large scale and sometimes interact with other people from around the world. Multiplayer video games include a variety of gameplay types representing many video game genres.

### SUMMARY

Embodiments of the present invention disclose a method, computer program product, and system for adjusting a fee for a game. A computer system identifies a ranking of a user. A computer system identifies a fee for a user of a game. A computer system determines an amount to adjust the fee for the user of the game based upon the ranking of the user. Responsive to determining the amount to adjust the fee, a computer system updates the fee for the user of the game.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of one exemplary implementation of a game reward program, on a proxy server computer within the data processing environment of FIG. 1, for adjusting subscription rates, in accordance with an embodiment of the present invention.

FIG. 3 depicts a block diagram of components of the server computer executing a game program, UI, and reward program, in accordance with an embodiment of the present invention.

### DETAILED DESCRIPTION

Embodiments of the present invention allow for an incentive to increase game play for user-based software, for example, video games. Currently, participants of video games try to advance based on pride, and the thrill of playing a game. Embodiments of the present invention allow for developers or administrative users of a video game to increase the time participants are active and to increase the number of subscribers by adjusting the fee based upon a ranking of a participant, the time a participant spends on a game, outcomes of rounds or tournaments, etc. Increasing the number of participants that play a game and the amount of time those participants play the game is beneficial for a developer or administrative user because increased participation can generate more revenue and result in a better gaming environment which may further entice more participants to subscribe. Embodiments of the present invention recognize that in a newly released gaming environment, expedited population by participants within the environment can enable increased participant options within the game, and can potentially cause the game to be more entertaining.

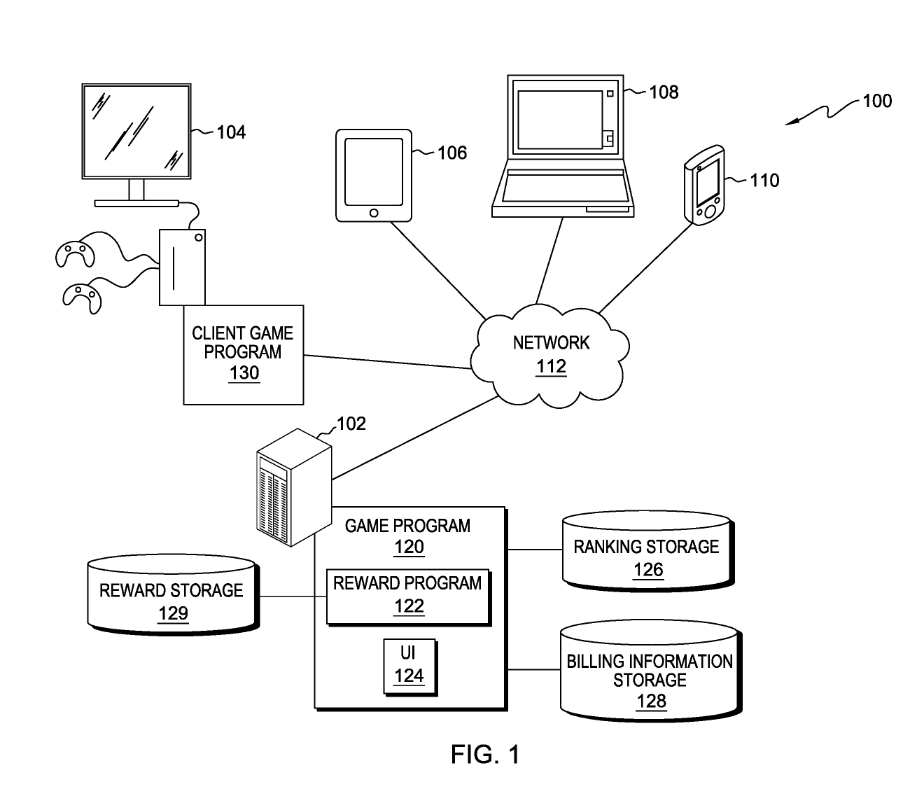

The present invention will now be described in detail with reference to the Figures. FIG. 1 is a functional block diagram illustrating a distributed data processing environment, generally designated 100, in accordance with one embodiment of the present invention. FIG. 1 provides only an illustration of one embodiment and does not imply any limitations with regard to the environments in which different embodiments may be implemented.

Distributed data processing environment 100 includes server computer 102 and client devices 104, 106, 108, and 110 all interconnected over network 112.

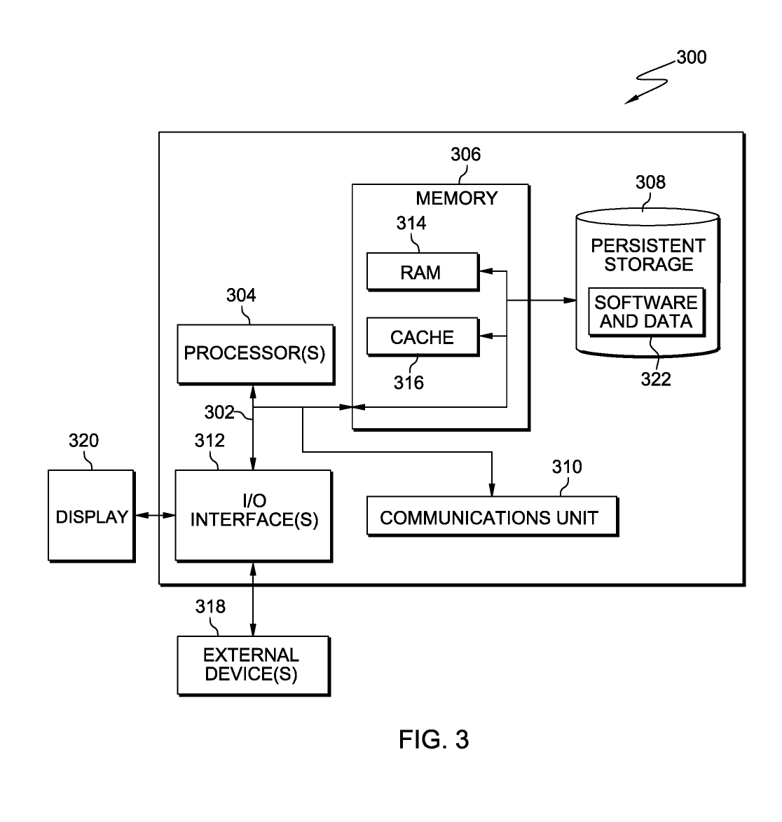

In example embodiments, server computer 102 may be a desktop computer, a laptop computer, a tablet computer, a specialized computer server, a smartphone, a gaming system, or any other computer system known in the art. In certain embodiments, server computer 102 represents a computer system utilizing clustered computers and components (e.g., database server computers, application server computers, etc.) that act as a single pool of seamless resources when accessed through network 112, as is common in data centers and with cloud computing applications. In general, server computer 102 is representative of any programmable electronic device or combination of programmable electronic devices capable of executing machine readable program instructions and communicating with client computers, such as client computers 104, 106, 108, and 110 via network 112. One embodiment of exemplary components of server computer 102 are described in greater detail with regard to FIG. 3.

In various embodiments of the present invention, client computers 104, 106, 108, and 110 can each be a laptop computer, a tablet computer, a netbook computer, a personal computer (PC), a desktop computer, a personal digital assistant (PDA), a smartphone, a gaming system, or any programmable electronic device capable of executing machine-readable program instructions, as described in greater detail with regard to FIG. 3, in accordance with embodiments of the present invention. FIG. 1 is just one embodiment of the invention's environment, in various other embodiments there can be fewer or greater numbers of client computers.

In general, network 112 can be any combination of connections and protocols that will support communications between server computer 102 and client computers 104, 106, 108, and 110, in accordance with embodiments of the present invention. Network 112 can include, for example, a local area network (LAN), a wide area network (WAN) such as the Internet, a cellular network, or any combination of the preceding, and can further include wired, wireless, and/or fiber optic connections.

Game program 120 is a generic game program or software application. Game program 120 updates and stores information to ranking storage 126 and billing information storage 128. In one embodiment, game program 120 resides on server computer 102 and facilitates maintenance of ranking storage 126 and billing information storage 128, as well as the communication or sharing of information with client computers 104, 106, 108, and 110. Game program 120 also facilitates the maintenance of the video game environment as well as all information associated with the video game. In some embodiments, game program 120 may be another type of software that includes gamification, the use of game thinking and game mechanics in non-game contexts to engage users for non-game purposes.

Ranking storage 126 is a database that stores information pertaining to rankings of a participant of game program 120 as compared to other participants of game program 120, based preset configurations by the developer or administrative user of game program 120. In one embodiment, rankings are based on points obtained while playing a round of game program 120. In another embodiment, rankings are based on time spent logged into game program 120. In one example, points used to rank participants of game program 120 are determined by preset goals created by the developers or other administrative users of game program 120. In another example, a ranking of a participant of game program 120 may be determined based on the number of wins in a competition, similar to a chess ranking. In various embodiments, the ranking may be based off of specific goals or achievements built into game program 120, the amount of time a participant of game program 120 has been playing, or a combination of the two. In another embodiment, reward program 122 may monitor game program 120 and generate leaderboards that rank game participants externally from game program 120 and externally from preexisting leaderboards of game program 120. In an embodiment, a leaderboard is created using one metric of skill to rank a first player versus the level of skill of a second player.

Billing information storage 128 is a database that stores information pertaining to a participant of game program 120, such as payment information, subscription status, billing address, or other information.

Ranking storage 126 and billing information storage 128 can be implemented with any type of storage device, for example, persistent storage 308 (see FIG. 3), which is capable of storing data that may be accessed and utilized by client computers 104, 106, 108, and 110, and server computer 102, such as a database server, a hard disk drive, or a flash memory. In other embodiments, ranking storage 126 and billing information storage 128 can represent multiple storage devices within server computer 102, reside on another server, or another computing device, provided that they are accessible to client game program 130, reward program 122, and game program 120. Ranking storage 126 and billing information storage 128 may each be a repository that may be written and read by game program 120, reward program 122, and/or client game program 130.

In the depicted embodiment, client game program 130 is located on client computer 104 and sends notifications of inputs by a participant to game program 120 located on server computer 102. In one embodiment, client game program 130 is located on client computer 104. In other embodiments, client game program 130 may be located on server 102, client computer 106, client computer 108, client computer 110, or any other computing device, provided client game program 130 is accessible to game program 120 via network 112, and provided client game program 130 has access to network 112.

In one embodiment, server computer 102 is a server computer system accessible to a plurality of users of game program 120 (e.g., client computers 104, 106, 108, and 110). In such an embodiment, user interface 124 may be a Web-based user interface accessible to each respective user via network 112. For example, server computer 102 receives a notification that client computer 104 is attempting to log onto game program 120 located on server computer 102. Server computer 102 can receive the notification by way of any suitable network (e.g., network 112). Received communications and information may be displayed to a user of server computer 102 through user interface 124, and messages and instruction may be received from the user through user interface 124. A user interface refers to the information (such as graphic, text, and sound) a program presents to a user and the control sequences the user employs to control the program. There are many types of user interfaces. In one embodiment, the user interface may be a graphical user interface (GUI). A GUI is a type of user interface that allows users to interact with electronic devices, such as a keyboard and a mouse, through graphical icons and visual indicators, such as secondary notation, as opposed to text-based interfaces, typed command labels, or text navigation. In computing, GUIs were introduced in reaction to the perceived steep learning curve of command-line interfaces, which require commands to be typed on the keyboard. The actions in GUIs are often performed through direct manipulation of the graphics elements.

Reward program 122 resides on server computer 102 and utilizes rankings from ranking storage 126 and billing information storage 128 to determine rewards for client computers 104, 106, 108, and 110. Reward program 122 facilitates maintenance of reward storage 129 located on server computer 102. Reward storage 129 is a database that stores information pertaining to rewards to be applied to the account of a user of client computer 104, or any other client computer. In an embodiment, reward program 122 will determine rewards based off of rankings stored to ranking storage 126 and will incorporate a time the reward should be applied to a fee of a participant, such as a user of client computer 104. Reward storage 129 can be implemented with any type of storage device, for example, persistent storage 308, which is capable of storing data that may be accessed and utilized by client computers 104, 106, 108, and 110, and server computer 102, such as a database server, a hard disk drive, or a flash memory. In other embodiments, reward storage 129 can represent multiple storage devices within server computer 102, reside on another server, or another computing device, provided that it is accessible to client game program 130, reward program 122, and game program 120. Reward storage 129 may be a repository that may be written and read by game program 120, reward program 122, and/or client game program 130.

As depicted, reward program 122 is a subprogram or routine of game program 120. In an alternative embodiment, reward program 122 may be independent of game program 120 and capable of communicating or otherwise interacting with game program 120. In some embodiments, reward program 122 may monitor multiple different game programs that are related, or have the same developer or administrative user, to calculate a reward based on multiple game standings. In an alternate embodiment, reward program 122 may be on a separate computing device from game program 120.

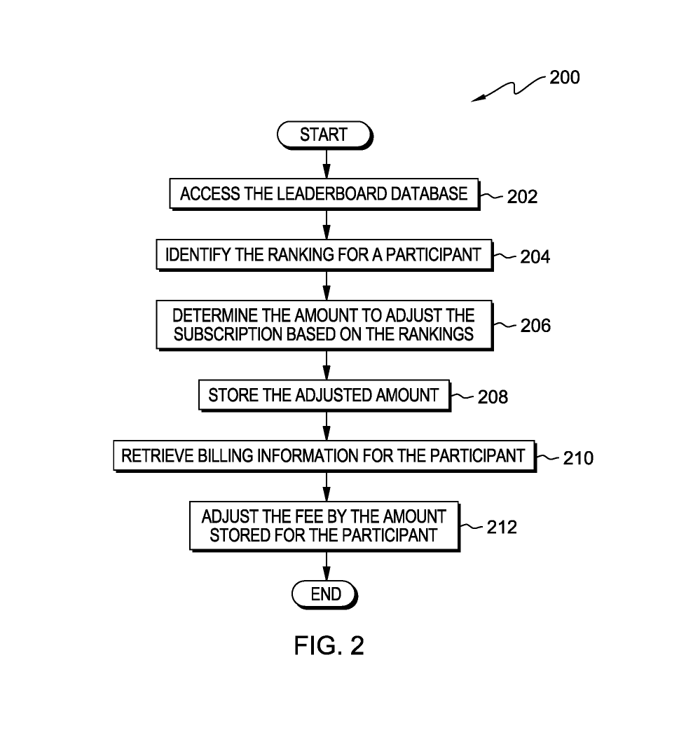

FIG. 2 is a flowchart depicting operational steps of one exemplary implementation of program 200, which is a function of reward program 122, located on server computer 102, in accordance with an embodiment of the present invention.

Reward program 122 accesses a leaderboard associated with game program 120 located on server computer 102 (step 202). In some embodiments, the leaderboard information may be stored in ranking storage 126, and reward program 122 may retrieve the leaderboard information from therein. In an embodiment, reward program 122 may access ranking storage 126 at set intervals to gather leaderboard information. In some embodiments, intervals may be set by a developer or other administrative user. Examples of intervals within which reward program 122 accesses ranking storage 126 may include monthly, biweekly, weekly, daily, hourly, or any other interval. In another embodiment, reward program 122 may access ranking storage 126 in real time. In yet another embodiment, reward program 122 only accesses ranking storage 126 at a specified time within a billing cycle of subscribers of game program 120. For example, reward program 122 accesses ranking storage 126 on the day before a participant is billed.

Reward program 122 identifies the ranking of a participant of game program 120 using information retrieved from ranking storage 126 (step 204). In one embodiment, reward program 122 identifies a participant of game program that is located within the top ten, based on the ranking for game program 120 retrieved in step 202. In some embodiments, reward program 122 may select, or otherwise identify, a particular number of participants based on, for example, participant ranking, total number of participants, or other factors. For example, if game program 120 has only a small number of participants, reward program 122 may identify the top five participants. In another example, if game program 120 has a large number of participants (e.g., millions), reward program 122 may identify the top 1000 participants. In an embodiment, reward program 122 may identify the ranking of a participant of game program 120 which may take place at the end of a billing cycle. In other embodiments, reward program 122 may only identify a participant of game program 120 after a tournament or battle in order to provide an increased incentive to participate in the tournament or battle. In another embodiment, reward program 122 may identify the rank of a participant of game program 120 daily, or according to some other time interval, and the information may be stored in reward storage 129.

Reward program 122 determines the amount by which to adjust a subscription fee of the selected participant based upon rankings in ranking storage 126 (step 206). In an embodiment, reward program 122 uses the ranking of a participant within a leaderboard of game program 120 to determine an amount by which to adjust the participant's subscription-based on a ratio set by the developer or administrative user of game program 120. An example of this could comprise a ranking of first place for a participant of game program 120, in which case the fee for the next billing cycle would be free. Another example may comprise a fifth place ranking for a participant of game program 120, in which the fee for the fifth ranked participant of game program 120 is be reduced by 95 percent. If, for example, there were a top one hundred participants of game program 120, out of a total of one thousand participants of game program 120, that were programmed to receive a reward, some embodiments of reward program 122 may reduce the fee for the top one hundred participants of game program 120. In one embodiment, this reduction could be determined by the percentage of the top participant of game program 120 that the participant comprises. For example, the sixth ranked participant of game program 120 would receive a 94 percent reduction in their fee for the next month, whereas the eighty-fifth ranked participant of game program 120 would receive a 15 percent reduction in their fee the next month.

In another embodiment, reward program 122 may determine the amount to reduce the fee for a participant of game program 120 every time reward program 122 identifies a top player or at any other time that the developer or administrative user of game program 120 determines a fee should be reduced for participants of game program 120. In one embodiment, participants are only eligible for rewards once or may only receive awards at a certain frequency, for example, yearly. In such an embodiment, reward program 122 may determine that a participant has previously had a fee reduction and therefore is not eligible for a reward. In some embodiments, reward program 122 may add an additional participant of game program 120 to replace the ineligible participant of game program 120. Some examples of fee reduction comprise, reward program 122 determining a subscription fee adjustment, reward program 122 determining an adjusted rate of advertisements that appear during game program 120 as a basis for a reward, or reward program 122 adjusting the fee for an in-game purchase. In one embodiment, the time period that an advisement is displayed to a user is adjusted based on their ranking.

Reward program 122 stores the amount to adjust the fee of the participant in reward storage 129 (step 208). In one embodiment reward program 122 stores the information generated from determining the amount to adjust a subscription fee (step 206) in reward storage 129, potentially for later use. In another embodiment, the adjusted subscription fee may be stored in billing information storage 128.

Reward program 122 retrieves personal information located in billing information storage 128 for a participant of game program 120 whom is to receive an adjustment in a fee for game program 120 (step 210). In an embodiment, reward program 122 locates a participant of game program 120 whom is to receive a reward from reward storage 129, and tags or otherwise annotates information related to the participant of game program 120, indicating the amount or percent of the reward, with the billing information of the participant. In an example, a participant of game program 120 may have the amount of the adjusted fee stored and associated with the participant's username in reward storage 129, and reward program 122 may add metadata to the named participant of game program 120 regarding their billing information such as credit card numbers, addresses, amounts to be billed, or any other pertinent billing information. In one embodiment, reward program 122 may associate an amount of an adjusted fee with a participant every time a new participant of game program 120 has information stored in reward storage 129. In another embodiment, billing information could be attached to a username of a participant of game program 120 as metadata. In one example, billing information that is stored in reward storage 129 for the participants of game program 120 may have to be added each time a billing cycle restarts, as old information may be deleted.

Reward program 122 adjusts the bill of a participant of game program 120 by adjusting the amount stored in reward storage 129 from the amount that is owed by the participant (step 212). In some embodiments, the amount owed by the participant is stored in billing information storage 128. In other embodiments, the amount owed by the participant is attached to the information pertaining to the participant in reward storage 129. In one embodiment, a participant of game program 120 may have received multiple adjustments towards a billing cycle and all adjustments would be applied to the bill. In certain embodiments, the adjustments for a participant of game program 120 may exceed the billing cycle's amount due. In such a situation, there may be a zero balance or, alternatively, the adjustments could carry over to the next billing cycle. In an embodiment, adjustments to a bill may not be applied until a future month. Alternatively, adjustments may not be given at all due to circumstances such as a violation of rules, or if a participant had exceeded the amount of a fee allowed to be adjusted. In one embodiment, reward program 122 will send an email, text, phone call, or any other form of messaging to the participant of game program 120 with information regarding the adjusted balance.

FIG. 3 depicts a block diagram of components of computer 300, which is representative of server computer 102 and client devices 104, 106, 108, and 110, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computer 300 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM) 314 and cache memory 316. In general, memory 306 can include any suitable volatile or non-volatile computer readable storage media. Software and data 322 are stored in persistent storage 308 for access and/or execution by processor(s) 304 via one or more memories of memory 306. With respect to client computers 104, 106, 108, and 110, software and data 322 represents client game program 130. With respect to server computer 102, software and data 322 represents game program 120, reward program 122, ranking storage 126, billing information storage 128, reward storage 129, and UI 124.

In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices. In these examples, communications unit 310 includes one or more network interface cards. Communications unit 310 may provide communications through the use of either or both physical and wireless communications links. Software and data 322 may be downloaded to persistent storage 308 through communications unit 310.

I/O interface(s) 312 allows for input and output of data with other devices that may be connected to computer 300. For example, I/O interface(s) 312 may provide a connection to external device(s) 318 such as a keyboard, a keypad, a touch screen, and/or some other suitable input device. External device(s) 318 can also include portable computer readable storage media such as, for example, thumb drives, portable optical or magnetic disks, and memory cards. Software and data 322 can be stored on such portable computer readable storage media and can be loaded onto persistent storage 308 via I/O interface(s) 312. I/O interface(s) 312 also connect to a display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for adjusting a fee for a game, the method comprising:
identifying, by one or more computer processors, a ranking of a user within a group of users of a game that utilizes a computing device wherein the ranking is based upon at least one metric indicating skill of the user in the game compared to the group of users of the game;
determining, by one or more computer processors, an amount of time, within a predefined time period, the user of the game is actively participating in the game;
determining, by one or more computer processors, points associated with the user of the game wherein the points are based on preset goals;
adjusting, by one or more computer processors, the identified ranking of the user of the game based on the determined amount of time and the determined points;
identifying, by one or more computer processors, a fee for the user of the game wherein the fee includes one of the following: a subscription-based fee and a fee for an in-game purchase;
determining, by one or more computer processors, that the adjusted ranking of the user of the game meets a fee adjustment threshold in a rankings category based on one of the following: an identified position within the adjusted ranking and a percentage of an overall total number of users within the adjusted ranking;
determining, by one or more computer processors, an amount to adjust the fee of the user based upon the user of the game meeting the fee adjustment threshold in the rankings category;
responsive to determining the amount to adjust the fee, updating, by one or more computer processors, the fee for the user of the game;
determining, by one or more computer processors, an amount to reduce advertisement time within the game for the user based upon the adjusted ranking of the user; and
responsive to determining the amount to reduce the advertisement time, updating, by one or more computer processors, the advertisement time within the game for the user of the game.
